(19) United States
(12) Patent Application Publication
(10) Pub. No.: US 2011/0247418 A1
(43) Pub. Date: Oct. 13, 2011

(54) SYSTEM AND METHOD FOR MONITORING A COMPRESSOR

(75) Inventors: Scott Mordin Hoyte, Fountain Inn, SC (US); Preston Keith Parker, Simpsonville, SC (US); Achalesh Kumar Pandey, Greenville, SC (US); Ravi Yoganatha Babu, Bangalore (IN); Bhasker Rao Keely, Bangalore (IN)

(73) Assignee: GENERAL ELECTRIC COMPANY, Schenectady, NY (US)

(21) Appl. No.: 12/756,585

(22) Filed: Apr. 8, 2010

(51) Int. Cl. G01N 29/04; F04D 29/00

(52) U.S. Cl. 73/602; 415/118

(57) ABSTRACT

A system for monitoring compressor anomalies includes an acoustic energy detector connected to the compressor and a controller in communication with the acoustic energy detector. The acoustic energy detector transmits an acoustic energy signal reflective of acoustic energy produced by the compressor to the controller. At least one sensor connected to the compressor measures an operating parameter of the compressor and transmits a parameter signal reflective of the operating parameter to the controller, A method for monitoring compressor anomalies includes sensing acoustic energy produced by the compressor and transmitting an acoustic energy signal reflective of the acoustic energy to a controller. The method further includes sensing at least one operating parameter of the compressor, transmitting a parameter signal reflective of the operating parameter to the controller, and transmitting an output signal based on the acoustic energy signal and the operating parameter signal.

### FIELD OF THE INVENTION

The present invention generally involves a system and method for monitoring the health of a compressor. More specifically, the present invention describes a system that combines acoustic energy sensors with statistically significant operational information to monitor the compressor, detects stress waves or other acoustic energy caused by compressor anomalies, and/or provides information reflective of the health of the compressor.

### BACKGROUND OF THE INVENTION

Compressors are widely used in industrial and commercial operations. For example, a typical gas turbine includes an axial compressor at the front, one or more combustors around the middle, and a turbine at the rear. The compressor includes a compressor casing that encloses multiple stages of rotating blades and stationary vanes. Ambient air enters the compressor, and the rotating blades and stationary vanes progressively impart kinetic energy to the working fluid (air) to bring it to a highly energized state. The working fluid exits the compressor and flows to the combustors where it mixes with fuel and ignites to generate combustion gases having a high temperature, pressure, and velocity. The combustion gases exit the combustors and flow to the turbine where they expand to produce work.

During operations, internal compressor components are continuously subjected to wear from corrosion, erosion, and foreign object debris entrained in the working fluid. High cycle fatigue may lead to the formation of cracks and other anomalies in the internal compressor components, such as corrosion of a stator vane or increased rubbing or friction between the rotor and stationary parts. Once formed, the cracks and other anomalies tend to propagate, increasing the risk that an internal compressor component may break apart or fail during operations, cause serious damage to personnel and equipment, and require extended shut down periods to repair or replace the damaged components.

Conventional systems and methods exist to monitor the performance and operation of compressors. For example, vibration sensors may be used to monitor vibrations from the compressor during operations. A change in the frequency or magnitude of existing vibrations may indicate excessive wear and/or crack formation. However, vibration sensors may only detect cracks and other anomalies that are large enough to cause an imbalance and vibration in the compressor. As a result, vibration sensors may not detect small cracks that do not result in a detectable vibration in the compressor.

Visual inspections are also used to monitor the performance and operation of compressors. For example, the compressor may be shut down and the casing may be removed to allow a visual examination of discrete locations inside the compressor. However, the visual inspections are time consuming, are limited to visually accessible components, require the compressor to be shut down, and can only detect existing cracks that are large enough to be visually discernable.

Therefore, it would be desirable to have an improved system and method for monitoring the performance and operation of a compressor that avoids some or all of the disadvantages associated with vibration detectors and visual detection.

### BRIEF DESCRIPTION OF THE INVENTION

Aspects and advantages of the invention are set forth below in the following description, or may be obvious from the description, or may be learned through practice of the invention.

One embodiment of the present invention is a system for monitoring compressor anomalies. The system includes an acoustic energy detector connected to the compressor and a controller in communication with the acoustic energy detector. The acoustic energy detector transmits an acoustic energy signal reflective of acoustic energy produced by the compressor to the controller. The system further includes at least one sensor connected to the compressor, and the at least one sensor measures an operating parameter of the compressor and transmits a parameter signal reflective of the operating parameter to the controller.

Another embodiment of the present invention is a system for monitoring compressor anomalies. The system includes an acoustic energy detector connected to the compressor, and the acoustic energy detector includes a sensor connected to an amplifier. The system further includes a controller in communication with the acoustic energy detector, and the acoustic energy detector transmits an acoustic energy signal reflective of acoustic energy produced by the compressor to the controller. At least one sensor connected to the compressor measures an operating parameter of the compressor and transmits a parameter signal reflective of the operating parameter to the controller,

The present invention also includes a method for monitoring compressor anomalies. The method includes sensing acoustic energy produced by the compressor and transmitting an acoustic energy signal reflective of the acoustic energy to a controller. The method further includes sensing at least one operating parameter of the compressor, transmitting a parameter signal reflective of the operating parameter to the controller, and transmitting an output signal based on the acoustic energy signal and the operating parameter signal.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 shows a system for monitoring a compressor according to one embodiment of the present invention; and

FIG. 2 shows a simplified diagram of an acoustic energy detector according to one embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

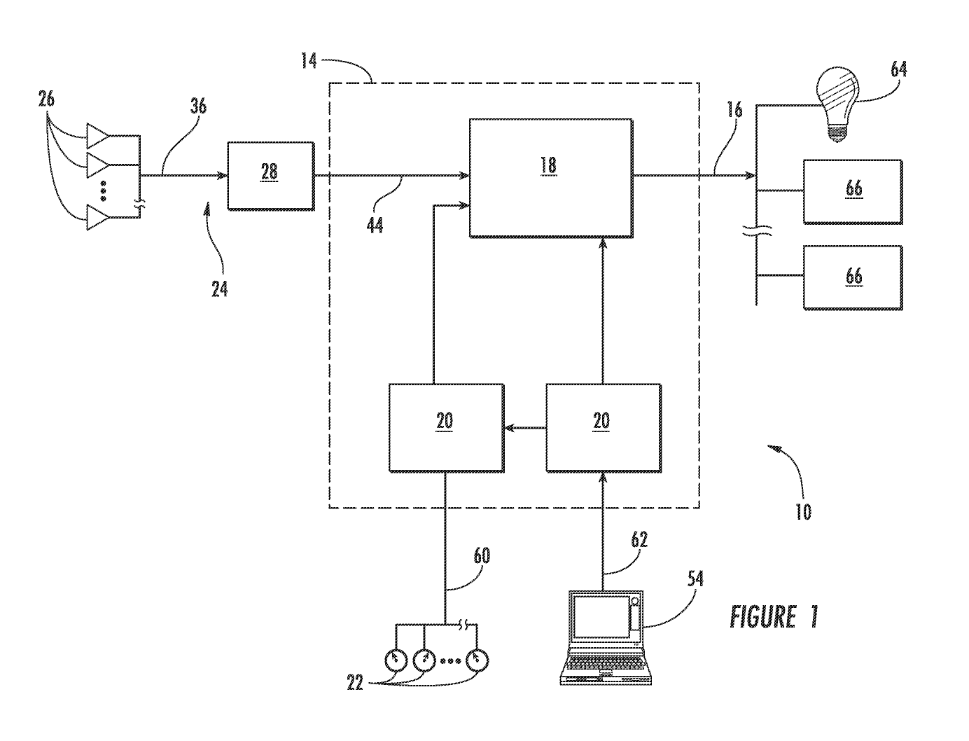

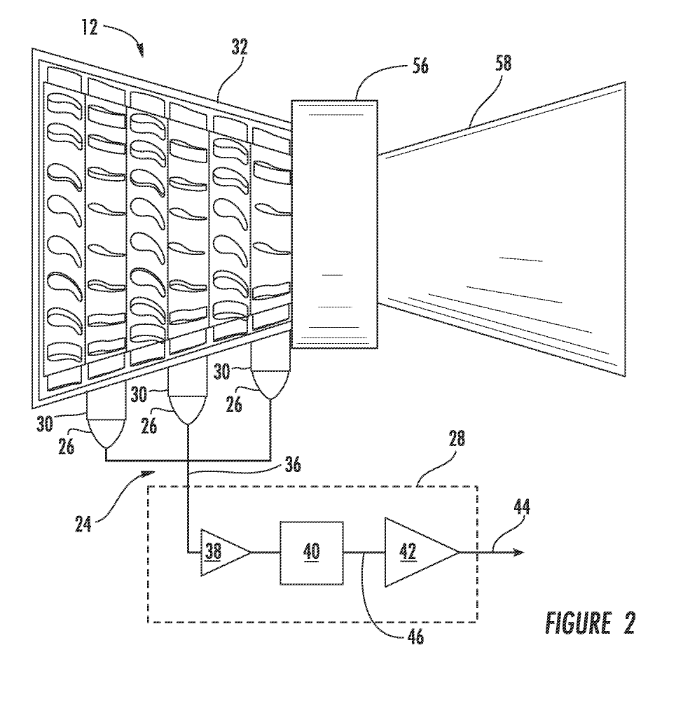

FIG. 1 shows a system 10 for monitoring a compressor 12 (shown in FIG. 2) according to one embodiment of the present invention. The system 10 generally includes a controller 14 that combines statistically significant information from a variety of sources to determine the operational status of the compressor 12 and generate an output signal 16. The controller 14 may include various components such as microprocessors 18, coprocessors, and/or memory/media elements 20 that store data, store software instructions, and/or execute software instructions. The various memory/media elements 20 may be one or more varieties of computer readable media, such as, but not limited to, any combination of volatile memory (e.g., RAM, DRAM, SRAM, etc.), non-volatile memory (e.g., flash drives, hard drives, magnetic tapes, CD-ROM, DVD-ROM, etc.), and/or other memory devices (e.g., diskettes, magnetic based storage media, optical storage media, etc.). Any possible variations of data storage and processor configurations will be appreciated by one of ordinary skill in the art.

The statistically significant information may include, for example, real-time information from sensors 22 connected to the compressor 12, historical information about the compressor 12 operations, repairs, and/or maintenance, and/or historical information about the operations, repairs, and maintenance of similar compressors. The output signal 16 may indicate, for example, an alarming condition requiring immediate attention, a suggested or modified inspection interval, a suggested or modified repair or maintenance schedule, and/or crack length information.

As shown in FIG. 1, the controller 14 receives information from an acoustic energy detector 24. The acoustic energy detector 24 may include one or more acoustic emission sensors and circuitry commonly available for sensing pressure transients or shock waves produced during crack initiation and/or propagation. For example, as shown in FIG. 2, the acoustic energy detector 24 may generally include one or more acoustic emission sensors 26 and a signal conditioner and generator 28. A suitable coupler 30, such as petroleum jelly, a lubricant, or similar viscous fluid, may be used to connect the sensor(s) 26 to a surface 32 of the compressor 12, such as the compressor casing, to enhance the transmission of acoustic energy from the compressor components to the sensor(s) 26. The sensor(s) 26 may include a magnetostrictive material or piezoelectric transducer that coverts a pressure transient or shock wave to an electrical signal 36. The signal conditioner and generator 28 may include a preamplifier 38, a filter 40, and an amplifier 42 to generate an acoustic energy signal 44 reflective of the acoustic energy produced by the compressor 12. The preamplifier 38 increases the electrical signal 36 produced by the sensor(s) 26, and the filter 40 removes noise from the electrical signal 36 and passes a filtered signal 46 to the amplifier 42 for further amplification.

The acoustic energy wave or shock wave may be produced, for example, by an anomaly in the compressor such as the initiation and/or propagation of a crack, corrosion of a stator vane, or rubbing between the rotor and stationary parts. The shock wave may be characterized as having one or more peak waves of approximately equal magnitude with subsequent secondary waves having a decreasing amplitude. The electrical signal 36 from the sensor(s) 26 may reflect information about the shock wave, such as the number, duration, frequency, time, and/or magnitude of the peak waves and/or the secondary waves. The filter 40 may include a predetermined threshold to modify the electrical signal 26 by removing background noise from the electrical signal 26 that does not exceed the predetermined threshold. The filter 40 then passes the filtered signal 46 to the amplifier 42. In particular embodiments, the filter 40 may include a frequency band pass filter that may be tuned or adjusted to screen particular frequencies of noise from the electrical signal 36 produced by the sensor(s) 26. In addition or alternately, the filter 40 may employ a process commonly referred to as binning to combine the electrical signals 36 from multiple sensors 26 and enhance the clarity of the acoustic energy signal 44 transmitted to the controller 14.

Referring back to FIG. 1, the controller 14 combines the acoustic energy signal 44 with information from one or more parameter sensors 22 and/or an input device 54. The parameter sensors 22 provide real-time or near real-time measurements of operating parameters of the compressor 12 or associated equipment, such as combustors 56 or a turbine 58 operating in conjunction with the compressor 12. Commonly measured operating parameters of the compressor 12 may include, for example, compressor discharge temperature, compressor pressure ratio, inlet guide vane angle, bearing temperatures, bearing vibrations, rotor vibrations, etc. Commonly measured operating parameters of associated equipment may include, for example, gas turbine load, fuel stroke reference, turbine speed, turbine exhaust temperatures, etc. Each parameter sensor 22 transmits a parameter signal 60 reflective of the operating parameter to the controller 14 for further processing.

The input device 54 allows a user to communicate with the system 10 and may include any structure for providing an interface between the user and the system 10. For example, the input device may include a keyboard, computer, terminal, tape drive, and/or any other device for receiving input from a user and generating a data signal 62 to the system 10.

The data signal 62 may include any available information about the compressor 12 and associated equipment 56, 58 stored in a database for use by the controller 14. For example, the data signal 62 may include fleet information collected about similar compressors and associated equipment that includes operational, repair, and/or maintenance information of statistical and historical significance. The data signal 62 may also include historical information about the particular compressor 12 and associated equipment 56, 58, such as the date and duration of previous operating levels, particular equipment configurations during previous operations, completed maintenance items, empirical test results, etc. The data signal 62 may also include prospective or forecasted events for the compressor 12 and associated equipment 56, 58, based on the fleet models, such as anticipated operating levels, equipment configurations, scheduled maintenance, compressor failure risk, and the predicted end-of-life for various components. The data signal 62 may also include programming modifications that the user desires to implement in the controller 14. For example, empirical data may become available that suggests a change in the fleet model used to predict crack initiation and/or propagation, rubbing events, and other compressor anomalies. As a result, the user may desire to alter the predetermined threshold, inspection and/or maintenance intervals, or other parameters programmed into the controller 14, and the user can communicate the changed programming to the controller 14 through the data signal 62 generated by the input device 54.

The parameter signal(s) 60 and data signal 62 from the parameter sensor(s) 22 and input device 54, respectively, may be transmitted to one or more data storage devices 20 via a wired or wireless communication network. Each data storage device 20 may be a computer memory storage device, for example, a hard drive, an optical disk, or a magnetic tape. The data storage device(s) 20 may be part of an on-site monitoring system integral to and/or local to the controller 14, as shown in FIG. 1, or they may be located remotely from the controller 14, possibly even remotely from the compressor 12 at an off-site location.

During operations, the controller 14 employs a sensor and information fusion technique to determine the operational status of the compressor 12. Specifically, the controller 14 receives the acoustic energy signal 44, one or more parameter signals 60, and any additional information provided by the user through the data signal 62. The controller 14 combines and filters all of this information to reach conclusions and recommendations about the operation and maintenance of the compressor 12. For example, the controller 14 may identify a crack initiation and/or propagation event in the compressor 12 based solely on a specific frequency and/or amplitude included in the acoustic energy signal 44. The controller 14 may further pinpoint the exact location of the suspected crack in the compressor 12 based on the time delay, frequency, magnitude, or any other characteristic of the acoustic energy signal 44.

Oftentimes, however, the useful information in the acoustic energy signal 44 may be obscured by noise from normal operating conditions or sporadic, but recurring events, thus limiting the ability of the controller 14 to reliably identify the onset or propagation of a crack or anomaly in the compressor 12. To improve the signal-to-noise ratio of the acoustic energy signal 44, the controller 14 may be programmed to apply known mathematical techniques to the acoustic energy signal 44, parameter signals 60, and/or data signal 62. For example, the controller 14 may be programmed to include, for example, Wavelet filter, a temporal Fast Fourier Transform (FFT), a chaotic series, frequency demodulation, a correlation integral, Bayesian statistics, etc. to identify time-series relationships between the acoustic energy signal 44, the parameter signals 60, and/or the data signal 62. The controller 14 may then retrieve empirical data from a memory storage device 20 or look up table that associates, for example, a particular crack size or location to an anticipated growth rate and ultimate component failure. The controller 14 may then fuse the time-series relationships with the empirical data to identify or predict upcoming events, such as stator vane cracking, compressor rubbing, casing cracking, excessive wear in rotating vanes, etc. Additional classification techniques, such as supervised and unsupervised techniques, may supplement the controller to classify acoustic emission events and anomalies.

As shown in FIG. 1, the controller 14 generates the output signal 16 that reflects the operational status of the compressor 12. For example, if the operational status of the compressor 12 indicates a sudden or catastrophic event has occurred that requires immediate attention, the output signal 16 may drive an alarm circuit 64, actuate a safety circuit, or trigger a combination of the two to ensure prompt operator action to address the situation. If, however, the operational status of the compressor 12 indicates a precursor of an event in the future, the output signal 16 may generate a message, event record 66, or other item that may be used to adjust the maintenance and/or shut down schedule for the compressor 12. In either event, the output signal 16 may also drive other protective features that protect the compressor 12, such as, for example, limiting the maximum operating level of the compressor 12, limiting the position of the inlet guide vane, limiting the compressor pressure ratio, etc.

The system 10 illustrated in FIG. 1 and the previous description may be used to provide a method for monitoring the performance of the compressor 12 and/or anomalies in the compressor 12. Specifically, the acoustic energy detector 24 may sense a release of acoustic energy or shock waves produced by crack initiation and/or propagation, rubbing, etc. in the compressor 12. The acoustic energy detector 24 may measure various characteristics of the shock wave, such as the amplitude and/or frequency of the shock wave, and transmit the acoustic energy signal 44 reflective of the acoustic energy to the controller 14. The system may further include one or more parameter sensors 22 that sense at least one operating parameter of the compressor 12 and transmit a parameter signal 60 reflective of the operating parameter to the controller 14, The controller 14 may fuse the collected signals 44, 60 and transmit the output signal 16 based on the acoustic energy signal 44 and the operating parameter signal 60.

In additional embodiments, the method for monitoring the performance of the compressor 12 or anomalies in the compressor 12 may include filtering the acoustic energy signal 44 based on the predetermined threshold and further filtering based upon the operating mode of the compressor 12 and associated equipment 56, 58. These operating modes may be calculated by using compressor and gas turbine operating parameters included in the parameter signal 60 and/or data signal 62. Still further embodiments may include transmitting the data signal 62 that reflects information about the compressor 12 from the input device 54 to the controller 14.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for monitoring compressor anomalies, comprising:
a. an acoustic energy detector connected to the compressor;
b. a controller in communication with said acoustic energy detector, wherein said acoustic energy detector transmits an acoustic energy signal reflective of acoustic energy produced by the compressor to said controller; and
c. at least one sensor connected to the compressor, wherein said at least one sensor measures an operating parameter of the compressor and transmits a parameter signal reflective of the operating parameter to said controller.

2. The system for monitoring compressor anomalies as in claim 1, wherein said acoustic energy detector includes a filter having a predetermined threshold, and said filter modifies said acoustic energy signal based on said predetermined threshold.

3. The system for monitoring compressor anomalies as in claim 1, further including an input device that transmits a data signal to said controller, wherein said data signal reflects information about the compressor.

4. The system for monitoring compressor anomalies as in claim 1, further including a plurality of sensors connected to the compressor, wherein said plurality of sensors measure multiple operating parameters of the compressor and transmit parameter signals reflective of the operating parameters to said controller.

5. The system for monitoring compressor anomalies as in claim 1, further including an output device in communication with said controller.

6. The system for monitoring compressor anomalies as in claim 5, wherein said controller transmits an output signal based on said acoustic energy signal and said parameter signal to said output device.

7. A system for monitoring compressor anomalies, comprising:
a. an acoustic energy detector connected to the compressor, wherein said acoustic energy detector includes a sensor connected to an amplifier;
b. a controller in communication with said acoustic energy detector, wherein said acoustic energy detector transmits an acoustic energy signal reflective of acoustic energy produced by the compressor to said controller; and
c. at least one sensor connected to the compressor, wherein said at least one sensor measures an operating parameter of the compressor and transmits a parameter signal reflective of the operating parameter to said controller.

8. The system for monitoring compressor anomalies as in claim 7, wherein said sensor is a piezoelectric transducer.

9. The system for monitoring compressor anomalies as in claim 7, wherein said acoustic energy detector includes a filter having a predetermined threshold, and said filter modifies said acoustic energy signal based on said predetermined threshold.

10. The system for monitoring compressor anomalies as in claim 7, further including an input device that transmits a data signal to said controller, wherein said data signal reflects information about the compressor.

11. The system for monitoring compressor anomalies as in claim 7, further including a plurality of sensors connected to the compressor, wherein said plurality of sensors measure multiple operating parameters of the compressor and transmit parameter signals reflective of the operating parameters to said controller.

12. The system for monitoring compressor anomalies as in claim 7, further including an output device in communication with said controller.

13. The system for monitoring compressor anomalies as in claim 12, wherein said controller transmits an output signal based on said acoustic energy signal and said parameter signal to said output device.

14. A method for monitoring compressor anomalies, comprising:
a. sensing acoustic energy produced by the compressor;
b. transmitting an acoustic energy signal reflective of the acoustic energy to a controller;
c. sensing at least one operating parameter of the compressor;
d. transmitting a parameter signal reflective of the operating parameter to said controller; and
e. transmitting an output signal based on said acoustic energy signal and said operating parameter signal.

15. The method for monitoring compressor anomalies as in claim 14, further including filtering said acoustic energy signal based on a predetermined threshold.

16. The method for monitoring compressor anomalies as in claim 14, further including transmitting a data signal to said controller, wherein said data signal reflects information about the compressor.

17. The method for monitoring compressor anomalies as in claim 14, further sensing multiple operating parameters of the compressor and transmitting parameter signals reflective of the operating parameters to said controller.

18. The method for monitoring compressor anomalies as in claim 14, further including measuring the amplitude of the acoustic energy produced by the compressor.

19. The method for monitoring compressor anomalies as in claim 14, further including measuring the frequency of the acoustic energy produced by the compressor.

20. The method for monitoring compressor anomalies as in claim 14, further measuring the duration of the acoustic energy produced by the compressor.
